(19) United States
(12) Patent Application Publication
(10) Pub. No.: US 2025/0246719 A1
(43) Pub. Date: Jul. 31, 2025

(54) BATTERY PACK STRUCTURE

(71) Applicant: TOYOTA JIDOSHA KABUSHIKI KAISHA, Toyota-shi (JP)

(72) Inventor: Shinya GOITSUKA, Nisshin-shi (JP)

(73) Assignee: TOYOTA JIDOSHA KABUSHIKI KAISHA, Toyota-shi (JP)

(21) Appl. No.: 18/921,002

(22) Filed: Oct. 21, 2024

(30) Foreign Application Priority Data
Jan. 25, 2024 (JP) 2024-009508

(51) Int. Cl. H01M 10/6568; H01M 10/613; H01M 50/204; H01M 50/271

(52) U.S. Cl. CPC H01M 10/6568; H01M 10/613; H01M 50/204; H01M 50/271

(57) ABSTRACT

The battery pack structure includes: a first battery pack in which a first battery module including a plurality of stacked battery cells is housed in a first case and a first cover that seals the first case from above; and a second battery pack located below the first battery pack, wherein a second battery module including a plurality of stacked battery cells is housed in a second case and a second cover that seals the second case from below.

### CROSS-REFERENCE TO RELATED APPLICATION

This application claims priority to Japanese Patent Application No. 2024-009508 filed on Jan. 25, 2024, incorporated herein by reference in its entirety.

### BACKGROUND

### 1. Technical Field

The present disclosure relates to a battery pack structure.

### 2. Description of Related Art

Japanese Unexamined Patent Application Publication No. 2015-115285 (JP 2015-115285 A) discloses a power supply device in which battery packs are stacked vertically in such a posture that top surfaces of the battery packs face each other.

### SUMMARY

In the power supply device of JP 2015-115285 A, a passage in which a heat exchange medium passes is provided on a lower end surface, and there is a risk that a liquid leakage occurs and causes a short circuit at a time of interference from a passage surface side.

Moreover, in the power supply device of JP 2015-115285 A, the passage in which the heat exchange medium passes, and a discharge route of gas generated from each of the battery packs, are provided on both upper and lower end surfaces, and a package efficiency is not good.

The present disclosure has been made in view of the matters, and an objective of the present disclose is to provide a battery pack structure that suppresses a short circuit at a time of interference and has a good package efficiency.

A battery pack structure relating to the present disclosure includes a first battery pack in which a first battery module constituted of a plurality of stacked battery cells is stored in a first case and a first cover that seals the first case from above, and a second battery pack in which a second battery module positioned below the first battery pack and constituted of a plurality of stacked battery cells is stored in a second case and a second cover that seals the second case from below.

According to the present disclosure, a battery pack structure can be realized that suppresses a short circuit at a time of interference and has a good package efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery pack structure according to an embodiment; and

FIG. 2 is a configuration diagram of a battery pack structure according to an example.

### DETAILED DESCRIPTION OF EMBODIMENTS

A battery pack structure according to an embodiment of the present disclosure will be described with reference to the drawings. Incidentally, the constituent elements in the following embodiments include those that can be easily replaced by a person skilled in the art or those that are substantially the same.

### Embodiment

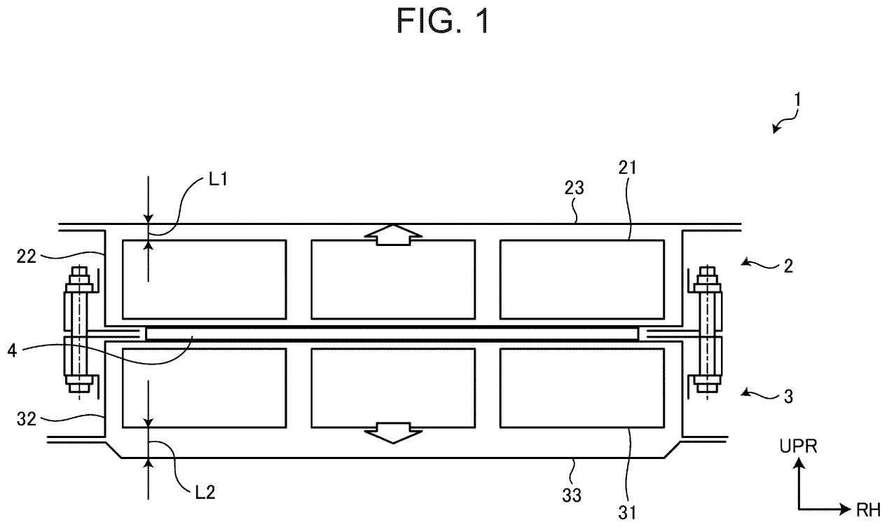

FIG. 1 is a schematic configuration diagram of a battery pack structure according to an embodiment. UPR shown in FIG. 1 represents the upper part of the vehicle on which the battery pack structure 1 is mounted, and RH represents the right side of the vehicle on which the battery pack structure 1 is mounted. The battery pack structure 1 includes a first battery pack 2, a second battery pack 3 positioned below the first battery pack 2, and a cooler 4 disposed between the first battery pack 2 and the second battery pack 3.

The first battery pack 2 includes three first battery modules 21 arranged in the horizontal direction, a first case 22, and a first cover 23. The first battery modules 21 are accommodated in the first case 22 and the first cover 23 that seals the first case 22 from above so that the upper side faces upward of the vehicle. However, the number and orientation of the first battery modules 21 are not particularly limited.

The second battery pack 3 includes three second battery modules 31 arranged in the horizontal direction, a second case 32, and a second cover 33. The second battery modules 31 are housed in the second case 32 and the second cover 33 that seals the second case 32 from below so that the upper side faces downward of the vehicle. However, the number and orientation of the second battery modules 31 are not particularly limited.

The first battery modules 21 and the second battery modules 31 are each composed of a plurality of stacked battery cells, and an electrode body accommodated in the battery cells includes a solid electrolyte.

The first case 22 and the second case 32 are made of the same material and have the same shape, and are arranged such that the opening portions are located on opposite sides of each other.

The rigidity of the second cover 33 is greater than the rigidity of the first cover 23. Specifically, the first cover 23 and the second cover 33 are designed to have different materials and plate thicknesses, and thereby have predetermined rigidity.

The distance L2 between the second cover 33 and the second battery module 31 is larger than the distance L1 between the first cover 23 and the first battery module 21. As an example, the distance L2 between the second cover 33 and the second battery module 31 is 20 mm, and the distance L1 between the first cover 23 and the first battery module 21 is 7 mm.

The cooler 4 cools the first battery modules 21 and the second battery modules 31 with a cooling liquid.

According to the embodiment described above, since the flow path of the cooling liquid is not disposed on the lower end surface of the battery pack structure 1, it is prevented that the liquid leaks and short-circuits occur at the time of interference from the road surface side.

Further, according to the embodiment, the second cover 33 has a large stiffness and a large distance L2 between the second cover 33 and the second battery module 31, and this space serves as an energy absorption (EA) space. Therefore, it is possible to prevent a short circuit due to the occurrence of liquid leakage at the time of interference from the road surface side.

Further, according to the embodiment, since the cooler 4 is disposed outside the first battery pack 2 and the second battery pack 3, even if liquid leakage occurs during interference, it is difficult for the liquid to enter the inside of the first battery pack 2 and the second battery pack 3.

Further, according to the embodiment, since the cooler 4 is disposed between the first battery pack 2 and the second battery pack 3, the package efficiency is high.

Further, according to the embodiment, the second cover 33 has a large rigidity and a large distance L2 between the second cover 33 and the second battery module 31, and this space functions as a flue gas space.

Further, according to the embodiment, since the rigidity of the first cover 23 is small, the first cover 23 is deformed due to interference from the outside, and a flue gas space is secured, so that the package efficiency is improved.

Further, according to the embodiment, since the first case 22 and the second case 32 are the same member made of the same material and having the same shape, it is possible to restrain an increase in the number of types of components.

### EXAMPLE

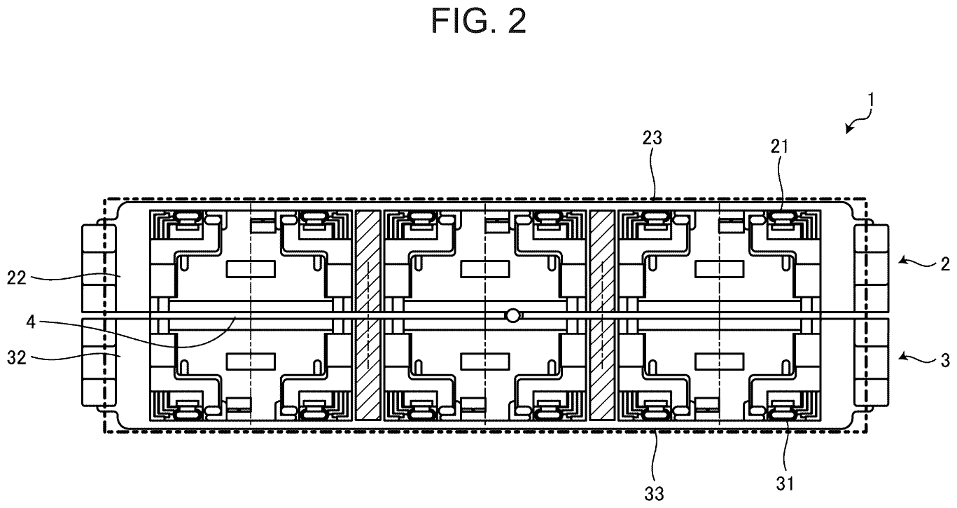

FIG. 2 is a configuration diagram of a battery pack structure according to an example. As shown in FIG. 2, the battery pack structure 1 described in the embodiment can be realized.

Further advantages and variations can be readily derived by one of ordinary skill in the art. Thus, the broader aspects of the disclosure are not limited to the specific details and representative embodiments presented and described above. Accordingly, various modifications may be made without departing from the spirit or scope of the general inventive concept as defined by the appended claims and their equivalents.

What is claimed is:

1. A battery pack structure comprising:
a first battery pack in which a first battery module constituted of a plurality of stacked battery cells is stored in a first case and a first cover that seals the first case from above; and
a second battery pack in which a second battery module positioned below the first battery pack and constituted of a plurality of stacked battery cells is stored in a second case and a second cover that seals the second case from below.

2. The battery pack structure according to claim 1, further comprising a cooler that cools the first battery module and the second battery module, the cooler being disposed between the first battery pack and the second battery pack.

3. The battery pack structure according to claim 1, wherein rigidity of the second cover is greater than rigidity of the first cover.

4. The battery pack structure according to claim 1, wherein the first case and the second case are made of a same material and have a same shape, the first case and the second case being disposed such that an opening portion of the first case and an opening portion of the second case are positioned on opposite sides from each other.

5. The battery pack structure according to claim 1, wherein a distance between the second cover and the second battery module is greater than a distance between the first cover and the first battery module.
